(19) United States
(12) Patent Application Publication
(10) Pub. No.: US 2026/0350422 A1
(43) Pub. Date: Nov. 5, 2026

(54) RETRIEVAL AUGMENTED GENERATION ERROR IDENTIFICATION AND REDUCTION

(71) Applicant: International Business Machines Corporation, Armonk, NY (US)

(72) Inventors: Anto Ajay Raj John, BANGALORE (IN); Vishnupriya C, BANGALORE (IN)

(73) Assignee: International Business Machines Corporation, Armonk, NY (US)

(21) Appl. No.: 19/194,278

(22) Filed: Apr. 30, 2025

(51) Int. Cl. G06N 5/02; G06F 40/20

(52) U.S. Cl. CPC G06N 5/02; G06F 40/20

(57) ABSTRACT

An embodiment receives a first input topic by a question generating agent. The embodiment generates using the question generating agent a first set of questions based on the first input topic. The embodiment generates using a question-answering agent a first answer to a first question of the first set of question. The embodiment executes a first program instruction to transmit feedback data to the question-answering agent, the feedback data produced by analyzing content of the first answer. The embodiment modifies a portion of the first answer based on the feedback data producing a revised first answer. The embodiment updates a SME database corresponding to the first input topic by incorporating additional data from the revised first answer into the SME database.

### BACKGROUND

The present invention relates generally to artificial intelligence. More particularly, the present invention relates to a method, system, and computer program for retrieval augmented generation error reduction.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries.

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior.

A Large Language Model (LLM) is a type of machine learning model designed for natural language processing tasks. An LLM may be trained on immense amounts of data, enabling the LLM to be capable of understanding and generating natural language and other types of content to perform a wide range of tasks. LLMs today may have the ability to infer from context, generate coherent and contextually relevant responses, translate between different languages, summarize text, answer questions, respond to queries, and even assist in creative writing or code generation tasks.

An artificial intelligence (AI) agent refers to a system or program that is capable of autonomously performing tasks on behalf of a user or another system by designing its workflow and utilizing available tools. AI agents can encompass a wide range of functionalities beyond natural language processing including decision-making, problem-solving, interacting with external environments, and executing actions. These agents can be deployed in various applications to solve complex tasks in various contexts from software design and IT automation to code-generation tools and conversational assistants. AI agents often leverage large language models (LLMs) to comprehend and respond to user inputs step-by-step and determine when to call on external tools. AI agents are sometimes referred to as LLM agents if they incorporate an LLM in their functioning.

Retrieval Augmented Generation (RAG) is a natural language processing framework that combines information retrieval and text generation components to produce coherent and contextually relevant text. The process retrieves information from a dataset or knowledge base using retrieval techniques and utilizes natural language processing models to generate human-like text based on the retrieved information. RAG typically includes components for retrieval, generation, ranking, and a feedback loop to continuously improve the quality of the generated text.

### SUMMARY

The illustrative embodiments provide for retrieval augmented generation error reduction. An embodiment includes receiving a first input topic by a question generating agent. The embodiment also includes generating using the question generating agent a first set of questions based on the first input topic. The embodiment also includes generating using a question-answering agent a first answer to a first question of the first set of questions. The embodiment also includes causing, responsive to the generating the first answer, an execution of a first program instruction to transmit feedback data to the question-answering agent, the feedback data produced by analyzing content of the first answer. The embodiment also includes causing, responsive to receiving the feedback data, an execution of a second program instruction to modify a portion of the first answer based on the feedback data, the execution of the second program instruction producing a revised first answer. The embodiment also includes causing, responsive to producing the revised first answer, an execution of a third program instruction to update an SME database corresponding to the first input topic, wherein updating the SME database comprises a combination of incorporating additional data, removing selected data, and/or otherwise modifying selected data from the revised first answer into the SME database.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example computing environment in accordance with an illustrative embodiment;

FIG. 3 depicts a block diagram of an example software module in accordance with an illustrative embodiment;

FIG. 4 depicts a block diagram of an example retrieval augmented generation process in accordance with an illustrative embodiment;

FIG. 5 depicts a block diagram of an example automated retrieval augmented generation process in accordance with an illustrative embodiment; and

FIG. 6 depicts a flowchart of an example process for retrieval augmented generation in accordance with an illustrative embodiment.

### DETAILED DESCRIPTION

Large Language Models (LLMs) have emerged as a popular technology area in artificial intelligence, causing many enterprises to take interest in adapting LLMs for various tasks like customer support, content creation, code explainability, data analysis, and so forth. Even though LLMs are trained on huge amount of openly available web data, the models may nevertheless lack implicit understanding of proprietary, enterprise, or other data that is not publicly available, and may struggle with domain-specific variations leading to inaccuracies, irrelevancies, and hallucinations in their output responses.

For example, suppose a financial institution implements an LLM to help system programmers debug the system during failures. System programmers specialize in programming at a low level, dealing directly with hardware and system software. Their tasks of debugging low-level issues are often complex to diagnose, and often require specialized subject matter expertise, intensive documentation studying, and searching internal knowledge bases to understand the meaning of error messages and potential debugging strategies. LLMs can alleviate this intensive search by interpreting error messages, suggesting debugging strategies and providing insights into potential causes of issues. However, if an LLM provides a hallucinated answer to a system programmer during debugging, this output poses several risks, including incorrect fixes that can lead to code complications or creation of new bugs. Hallucinations output by LLMs can consume valuable time and resources and divert efforts from solving the actual issue.

In the context of natural language processing and Large Language Models (LLMs), a “hallucination” refers to a phenomenon where the model generates text that is not grounded in the input context or is not supported by the training data. Hallucinations occur when the LLM produces text that is semantically inconsistent, factually incorrect, or unrelated to the input prompt. This can happen when the model generates text based on its learned patterns rather than the actual context provided, leading to the creation of misleading or nonsensical information. Hallucinations are a common challenge in LLMs and can impact the overall quality and reliability of the generated text.

Further, LLMs may be less reliable in generating relevant output responses when internal or the proprietary enterprise data is hidden or inaccessible by the LLM. Accordingly, hallucinations are more frequent in cases where an LLM relies on primarily generic data and has limited amount of relevant data, and further and where the LLM has not been trained on or does not have access to proprietary and/or domain specific data.

For example, in a typical RAG architecture, the LLM will go and access data relevant to the question, which may be fetched by an LLM from a database (e.g., vector database), and the LLM agent will leverage the data as context when attempting to accomplish particular task. However, if the LLM only fetches a limited amount of data that provides a limited amount of context, then the entire context and related data may be hidden from the LLM, causing the LLM to generate an output response based on an incomplete or incorrect understanding of a query. In this case, since the LLM has a very limited understanding context and may generate an answer only with respect to that context which the LLM has accessed, the LLM is likely to provide an incorrect, incomplete, irrelevant, or otherwise unsatisfactory answer to an input query.

Accordingly, despite improvement in LLMs and prompt-engineering techniques, LLMs are nevertheless known to generate hallucinated and unreliable responses. The present disclosure addresses the deficiencies described above by providing a process (as well as a system, method, machine-readable medium, etc.) that develops a method of improving understanding of domain specific information by an LLM that reduces hallucinations and improves the functionality of the LLM in domain-specific specialized tasks. Embodiments of the present disclosure include a multi-agent system that is configured to interact to develop contextual relationships between datastores of an LLM based system and/or between data points within a datastore of an LLM based system.

Embodiments of the present disclosure include Retrieval Augmented Generation (RAG) framework that leverages a system or organization's internal data to provide context to the LLMs. The internal data store of an organization includes data of several formats and the correlation among this data provides the context which is understandable by the LLM. Accordingly, a data store refinement process through natural language feedback from a subject matter expert (SME) can be utilized to enrich the data store and implicitly establish the correlation among the data.

Embodiments of the present disclosure include a multi-agent platform for an SME to converse, evaluate and provide feedback to the LLM. The LLM incorporates this feedback and performs revisions based on the received feedback. These revisions may be stored in a revision data store. The revisions in the revision data store may be retrieved if they are related to the feedback and the revisions recommended to be made by the LLM, and these retrieved revisions guide the LLM for making revisions.

Embodiments of the present disclosure include performing a topic wise data store refinement process to obtain an enriched SME data store. On the completion of the session between the SME and LLM, the enriched SME data store has relationships among the data established implicitly through the LLM-SME conversation. The enriched SME data store utilized with RAG provides the LLM with an improved context to provide a highly accurate and relevant answer and reduced hallucinations in the LLM response.

As used throughout the present disclosure, the term “prompting” refers to the process of providing a specific input, typically in the form of text, to guide the generation of an output by a large language model (LLM). The prompt serves as a starting point and context for the model to generate coherent and relevant output based on the provided input. The prompt influences the content, style, and structure of the generated output by conditioning the LLM's generation process.

The prompting mechanism of an LLM includes several components that work together to guide the generation of text by the LLM. The prompt serves as the initial input that influences the content generated by the model. The prompt may include a few words, a sentence, a paragraph, a code snippet, an image, or any other digital media that provides the context or theme for the generated output. The prompt may be further concatenated with an input sequence. The input sequence includes the prompt and any additional context or information that the model uses to generate an output. By combining the prompt with the input sequence, the model can generate an output that is relevant to the given prompt. The model produces an output based on the prompt and input sequence, taking into account the language patterns and context learned during training. The output reflects the influence of the prompt on the generated content.

As used throughout the present disclosure, the term “hallucination” refers to an instance where an output generated by a machine learning model is not factually true, unsupported by the training data used to train the model, and/or not relevant to an intended output response based in the input prompt.

As used throughout the present disclosure, the term “retrieval augmented generation” (or simply “RAG”) refers to generating outputs using an LLM by incorporating information retrieval before generating responses. The retrieval augmented generation process typically involves two main stages: retrieval and generation. In the retrieval stage, relevant information is retrieved from a large dataset, knowledge base, or external source based on the input prompt or context. This retrieved information serves as additional context or input for the LLM, enriching the model's understanding of the topic and providing relevant information to guide the text generation process. Following the retrieval stage, the generation phase involves the LLM utilizing the retrieved information along with the input prompt to generate coherent and contextually relevant responses.

As used throughout the present disclosure, the term “subject matter expert” (or simply “SME”) refers to an individual or entity that possesses a deep understanding and expertise in a specific area or field. A subject matter expert is typically recognized as an authority in their domain due to their extensive knowledge, experience, and/or skills. SMEs are often involved in decision-making processes, problem-solving, training, and knowledge sharing within organizations, and are relied upon to provide guidance, insights, and solutions related to their area of expertise. Their expertise increases the accuracy, quality, and success of projects, products, and services. SMEs are employed in virtually every industry, including industries such as technology, healthcare, engineering, and more.

Illustrative embodiments provide for a multi-agent RAG system leveraging SME expertise to reduce output hallucinations and enhance LLM output. The multi agent system includes a plurality of LLM based agents working together to improve domain specific LLM functionality. In an embodiment, the multi agent system provides a platform for the SME to converse and provide feedback to the LLM. In an embodiment, the multi-agent system includes three agents: a Question Generation agent, a User Proxy agent, and Question Answering agent

Embodiments of the present disclosure include a process that provides automatic question generation around a subject area. Embodiments of the present disclosure further include automatic answer generation to a subset of the set of questions previously generated. In some embodiments, a SME provides feedback and/or modifies the contents of the generated questions and/or answers as part of a human-in-the-loop reinforcement learning process. In some embodiments, an LLM based agent executes the roles of an SME in curating questions and providing feedback to the generated answers. Executing the steps of the disclosed process causes creation of contextual relationship building within a datastore for a particular subject area and/or between different subject areas within a datastore and/or between datastores. Embodiments of the present disclosure further provide a process for enriching the data generated by executing the iterative question generating and answering processes. The enriched data may be stored and accessed by an LLM in execution of future tasks. The enriched data leveraged by the LLM reduces hallucinations and provides more accurate and relevant responses to prompts input into the LLM.

Embodiments of the present disclosure advantageously cause an LLM agent to have increased understanding of context when executing a task upon receiving an input prompt. Further, embodiments of the present disclosure do not require additional training or fine tuning of an LLM model, thereby reducing the computational resources ordinarily needed for retraining an LLM model. Further, embodiments of the present disclosure do not require updating and retraining a model with new information any time new information is available. Instead, the retrieval augmented generation process disclosed herein leverages a combination of agents to enhance data accessed by an LLM in generating a response.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

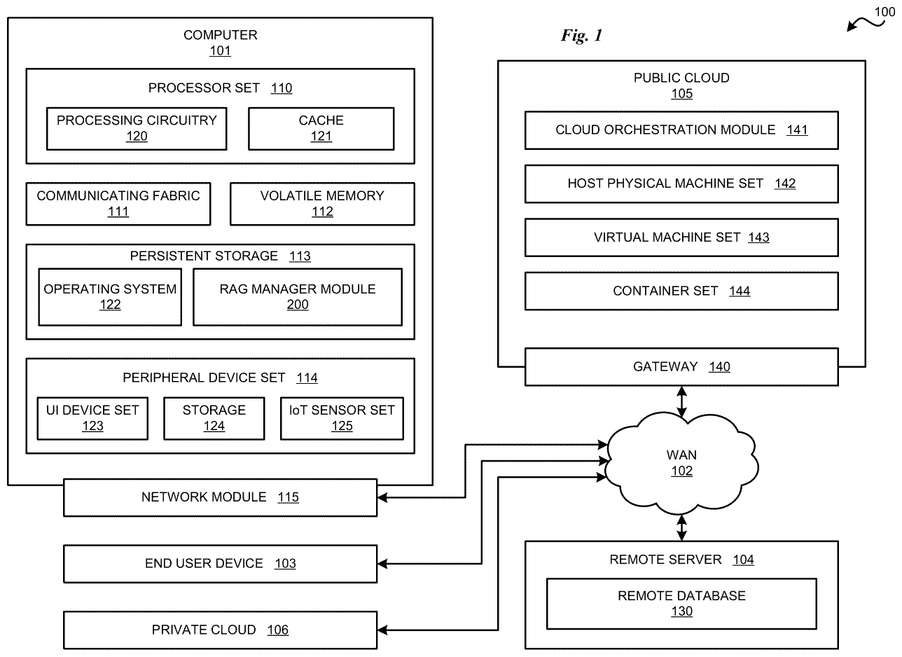

FIG. 1 depicts a block diagram of a computing environment 100. Computing environment 100 contains an example of an environment for the execution of at least some of the computer code involved in performing the inventive methods, such as RAG manager module 200 that provides prompting recommendations based on desired user outcomes. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

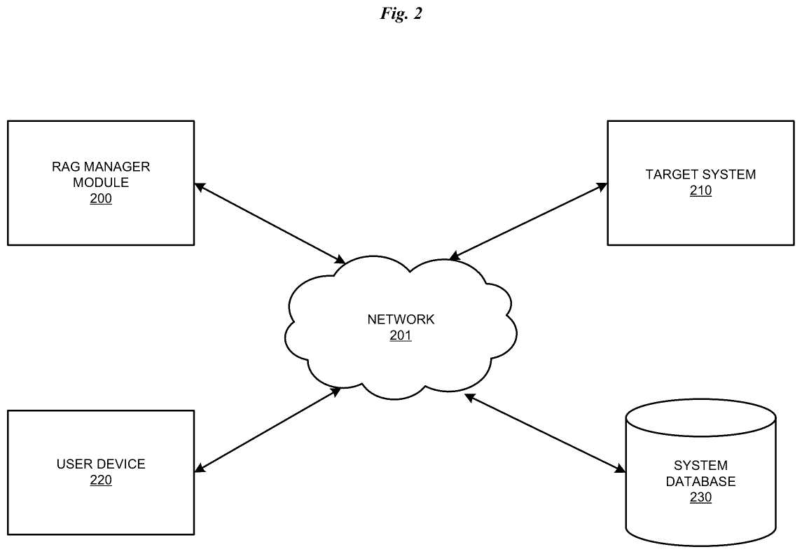

FIG. 2 depicts a block diagram of an example computing environment in accordance with an illustrative embodiment. In the illustrated embodiment, the RAG manager module 200 includes the RAG manager module 200 of FIG. 1.

In the illustrative embodiment, the RAG manager module 200 is configured to enrich data stores accessed by an LLM agent. In an embodiment, the RAG manager module 200 incorporates expertise of a SME through natural language feedback to the LLM and stores the feedback and revisions in a revision data store that may be accessed by the LLM when executing future tasks. The history of revisions stored on the revision data store guides the LLM to understand the SME feedback and learn to improve its answers. Further, the revision data store ensures consistent and persistent machine learning and provides creation of contextual relationships between data stored across various data stores of target system 210. In an embodiment, an SME accessing user device 220 prompts a large language model associated with target system 210 with an input topic. In an embodiment, the RAG manager module 200 interfaces between an LLM of target system 210, an SME, and system database 230.

In an embodiment, the interaction between the LLM and the SME facilitated by the RAG manager module 200 over any suitable network 201 causes real time learning by the LLM. The SME feedback may also provide inputs to the RAG manager module 200 to revise and refine the SME data stored on one or more separate data stores of system database 230. The revision and refinement processes cause establishing the relationships between data stored across one or more SME data stores corresponding to target system 210. Accordingly, the automatic establishment of relationship through data store refinement based on SME feedback eliminates the need manual creation and/or entry of entities and relationships.

The RAG manager module 200 provides automatic relationship building between data points that yields an enriched SME data store which may contain the correlation among the data points. The data store refinement facilitates enhanced data collection and improves the quality of data in the SME data store. The enriched SME data store enables a RAG system to retrieve relevant and improved context to aid an LLM in executing a task based on a query. Embodiments may be adapted for any system, organization, or enterprise to establish cross-relational context between topics or subject areas represented on digital documents stored on a database. Further, embodiments of the present disclosure eliminate the need for training or altering the weights of a large language model to adapt the model for a particular domain or use-case. Instead, RAG manager module 200 facilitates the refinement of the new data that may be leveraged by an LLM, which may be particularly well suited in environments where data is constantly changing, since there is no need to retrain the LLM on new data.

In an embodiment, the RAG manager module 200 retrieves data from an external knowledge source (e.g., domain specific data, enterprise data, etc.) for use as context for the LLM. The knowledge from various forms of enterprise data may be stored in the SME data store on target database 230. In an embodiment, the target system data is split into chunks or clusters and is stored in a vector datastore as documents. Each document has a metadata associated which may contain information, such as for example, the file name, topic, and so forth. The embeddings of the documents may also be stored in the vector store. The embeddings are the representations of the chunks in vector space and may be leveraged for similarity search during an information and/or document retrieval process executed by a retrieval mechanism. In an embodiment, the retrieval mechanism retrieves chunks from the target system data which are related to the input query through similarity search in the vector store corresponding to the system database 230 data store. The context will be provided with query to the LLM. The LLM produces a response based on the query and context.

In an embodiment, the RAG manager module 200 includes a multi-agent system that leverages SME expertise. The multi agent system may include LLM based agents working together to improve domain specific knowledge for LLMs. In an embodiment, the RAG manager module 200 provides a platform for the SME to converse and provide feedback to the LLM. In an embodiment, the multi-agent system includes three agents: a Question Generation agent, a User Proxy agent, and a Question Answering agent.

In the illustrated embodiment, the system database 230 includes a repository for all data related to target system 210. In an embodiment, the system database 230 stores all revision data that may be leveraged by a machine learning model to generate an output. In an embodiment, the system database 230 stores all revision data that may be leveraged by a generative artificial intelligence model. In an embodiment, the system database 230 stores all revision data that may be leveraged by an LLM-based agent or agents. In an embodiment, the system database 230 stores one or more sets of prompting instructions. In an embodiment, the system database 230 stores one or more sets of training data for training one or more machine learning models. In an embodiment, the system database 230 stores a history of all answers, feedback to answers, and revisions made to answers based on provided feedback.

In the illustrated embodiment, user device 220 includes a computing device configured to facilitate user interaction with the RAG manager module 200, thereby enabling a user to engage with the management of various operations related to target system 210. Accordingly, user device 220 may serve as an interface through which users can communicate instructions, commands, or requests to the RAG manager module 200, initiating related actions and overseeing the target system's performance. Through user device 220, a user can access a user interface or application that allows the user to interact with the RAG manager module 200. Users may input commands, configure settings, and monitor system performance through the interface provided by user device 220.

In an embodiment, user device 220 may support various communication channels, such as a graphical user interface (GUI), a command-line interface (CLI), a web-based portal, or a mobile application, depending on the system's design and user requirements. Users can communicate with the RAG manager module 200 in real-time to view visualizations related to operations disclosed herein.

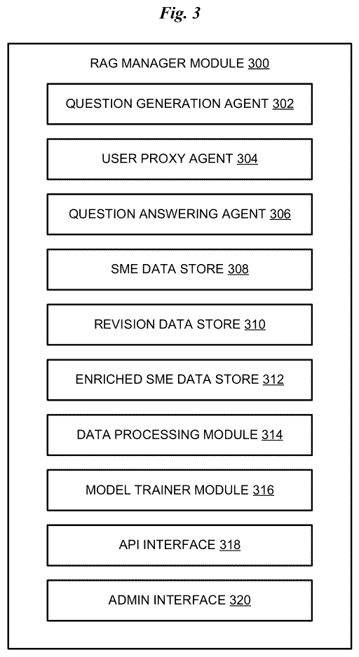

FIG. 3 depicts a block diagram of an example RAG manager software module 300 in accordance with an illustrative embodiment. In the illustrated embodiment, RAG manager module 300 is an example of RAG manager module 200 of FIGS. 1 and 2.

In the illustrated embodiment, the RAG manager module 300 includes a software module including a plurality of other software modules, including a question generation agent 302, a user proxy agent 304, a question answering agent 306, an SME data store 308, a revision data store 310, an enriched data store 312, a data processing module 314, a model trainer module 316, an API interface module 318, and an administrator interface module 320. In alternative embodiments, RAG manager module 300 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In some embodiments, the RAG manager module 300 comprises a physical computing device, including but not limited to, a general-purpose computer, a mainframe computer, a supercomputer, a quantum computer, a computer server, a personal computer, a laptop, a smartphone, a tablet, a personal digital assistant (PDA), etc., and any combination thereof. In some embodiments, the RAG manager module 300 comprises specialized hardware, such as for example, an Application-Specific Integrated Circuit (ASIC) or Field-Programmable Gate Array (FPGA) for accelerated processing of specific tasks, routines, algorithms, training operations, etc. In some embodiments, the RAG manager module 300 may include a combination of physical and virtualized components, as well as may be partially or entirely virtualized on a virtual machine.

In the illustrated embodiment, the question generation agent 302 includes an LLM based agent configured to generate a set of questions upon receiving an input topic. In an embodiment, the question generation agent module 302 includes a module for topic understanding configured for processing the input topic and extracting information such as keywords, concepts, and context. In an embodiment, the question generation agent module 302 employs one or more natural language processing techniques to analyze the topic and identify relevant details that will guide the question generation process.

For example, suppose the question generation agent 302 is input with the topic “Artificial Neural Network” and is thereby tasked with generating questions related to the input topic. The topic understanding module processes the input topic and extracts key components from documents related to neurons, layers, activation functions, and training algorithms. Based on the extracted information, the question template generation module creates a set of questions to delve into the underlying components of artificial neural networks.

Some examples of generated questions by the question generation agent 302 in response to the topic “Artificial Neural Network” might include: What is the role of a neuron in an artificial neural network and how does it process information? Explain the concept of different layers in a neural network architecture and their functions. How do activation functions such as ReLU and Sigmoid contribute to the non-linear behavior of neural networks? Discuss the backpropagation algorithm and its significance in training neural networks. Describe the impact of hyperparameters like learning rate and batch size on the performance of neural networks.

The input to the agent is a topic provided by the SME through the user proxy agent 304. Accordingly, the question generation agent 302 is to tasked with generating questions to aid the SME. The output of the agent is a list of questions returned to the SME. The question generating agent 302 may access the SME data store 308 to retrieve information that may provide context of the topic to generate questions. In an embodiment, the SME data store 308 may comprise SME subject matter knowledge sorted topic wise. Based on the input topic, the documents related to the topic are retrieved from the SME data store 308 and the retrieved documents are provided to the LLM for generating questions.

In an embodiment, the user proxy agent 304 includes a question selection module that is responsible for choosing questions from the set of questions generated by the question generation LLM-based agent to transmit to the question answering agent 306 for answering. The question selection module employs various criteria and algorithms to determine the most suitable questions for forwarding to the question answering agent. The question selection module may utilize relevance criteria to assess the alignment of each question with the user's query or information needs.

For example, questions that closely match the user's input topic or demonstrate high relevance to the context may be prioritized for transmission to the question answering agent 306. This ensures that the user receives answers that directly address their information requirements. Additionally, the question selection module may consider the complexity and difficulty level of the questions when making selection decisions. Questions that are well-suited to the user's knowledge level or that offer a gradual progression in understanding the topic are favored for transmission. By selecting questions of appropriate complexity, the user proxy agent 304 enhances the SME's ability promote effective learning or information retrieval. Furthermore, the question selection module may incorporate diversity criteria to ensure a broad coverage of the topic or to present contrasting perspectives on the subject matter. By selecting questions that offer diverse viewpoints or explore different aspects of the topic, the user proxy agent 304 enriches the user's learning experience and provides a comprehensive understanding of the subject.

In an embodiment, the user proxy agent 304 allows an SME to converse and provide feedback to the LLM in natural language. The SME through user proxy agent provides input topic to the question generating agent 302 and receives a list of questions as response from the question generating agent 302. From the list of questions received, the SME posts questions to the question answering agent 306 agent and provides feedback to the question answering agent 306. Accordingly, the user proxy agent 304 facilitates human-LLM interaction and incorporates expertise and knowledge of the SME for continuous improvement of the LLM.

In an embodiment, question answering agent 306 is tasked to answer the queries posted by the SME and to learn and incorporate the feedback provided by the SME. In an embodiment, question answering agent 306 comprises an LLM configured and uses a RAG framework to answer the domain specific queries. The RAG framework provides the LLM the context required, from the SME data store 308. The input to the agent is a topic and a query/question. The agent in return, provides a response to the query. The agent also receives feedback from the SME. The agent incorporates the feedback and revises the response accordingly. The revised answer is returned to the SME. The question answering agent 306 is associated with the revision data store 310 which is used to store the revisions of the LLM response.

The question answering agent 306 leverages the information stored in the SME data store 310 to enhance its ability to provide accurate and comprehensive answers to user queries. When presented with a question, the question answering agent may refer to the database to retrieve relevant facts, explanations, or supporting details that contribute to the formulation of a precise and informative response. By accessing the SME data store, the question answering agent can augment its knowledge base and improve the quality of answers provided to users.

The user proxy agent 304 utilizes the information stored in the SME data store 310 to validate answers to the questions generated by the question generation agent. After receiving answers from the question answering agent, the user proxy agent may cross-reference the responses with the data stored in the database to verify their accuracy and correctness. By comparing the answers against the factual information stored in the SME data store, the user proxy agent can assess the reliability of the responses and ensure that users receive valid and trustworthy information in response to their queries. This validation process enhances the credibility and integrity of the answers provided to users, fostering a more reliable and informative user experience.

The question selection module may also leverage user feedback or interaction data to adapt its selection process over time. By analyzing user responses to previously answered questions or monitoring user engagement patterns, the module can refine its question selection strategy to better cater to the user's preferences and information needs. This adaptive approach enhances the relevance and effectiveness of the questions transmitted to the question answering agent for answering.

In an embodiment, the revision data store 312 serves as a repository for additional data gathered based on feedback provided by the user proxy agent 304. The data stored in the revision data store is collected in response to user feedback, particularly regarding the answers provided to questions. When the user proxy agent receives feedback indicating the need for more information or a better response to a question, it triggers the retrieval and storage of supplementary data in the revision data store to enhance future interactions.

For instance, if a user provides feedback suggesting that an answer to a question was incomplete or inaccurate, the user proxy agent may determine that additional information is required to improve the response quality. In response to this feedback, the Question Answering Agent 306 accesses the revision data store to gather relevant facts, explanations, or supporting details that can address the user's concerns and enhance the accuracy and completeness of future responses.

In an embodiment, the revision data store 312 may store various types of data, including but not limited to expanded explanations, updated facts, clarifications, or references related to specific topics or questions. This additional data is curated based on user feedback and is intended to refine the knowledge base of the system, enabling it to provide more precise, informative, and satisfactory responses to user queries over time. By incorporating feedback-driven data into the revision data store, the system continuously learns and adapts to user preferences and information needs.

In an embodiment, revisions made by the LLM based on the SME feedback are stored in the revision data-store 312. When feedback is received by the question answering agent 306, the question answering agent 306 retrieves the related revisions from the revision datastore 310 to assist in revising and improving the answer. Any kind of new information, learnings or revisions are added to the revision data store 310. Based on the learnings and revisions during the conversation between user proxy agent 304 and the question answering agent 306, the SME data store is refined. The data store refinement causes implicit relationship establishment and improves the data store to maintain data efficiently.

In an embodiment, the enriched SME data store 312 includes a data store obtained after the topic wise refinement of the SME data-store. In an embodiment, the relationship among the data is established in this data store. The data store provides more insights and knowledge about the data in a manner which is understandable by the LLM. The data store aids in reducing the hallucinations of the LLM through its contextualized data contents. The modules aid in answering the user queries, accepting and incorporating feedback. It helps in improving LLM understanding and providing it with the capability of learning.

In an embodiment, the SME data store 308 comprises a database designed to store topic data related to various subjects or topics. The database within the SME data store is structured to accommodate information on a wide range of topics, and each topic entry in the database may contain relevant details, context, and factual information that can be accessed by different components of the RAG manager module 300. The question generation agent 302 can access the SME data store 310 to retrieve context details that are essential for generating meaningful and accurate questions. By querying the database, the question generation agent can retrieve background information, key concepts, and contextual details related to specific topics. This information serves as a foundation for formulating well-informed questions that are relevant to the topic at hand.

In the illustrated embodiment, the model trainer module 316 includes a software module configured to train one or more machine learning models described herein. In an embodiment, model training module 316 includes a data preparation module, an algorithm module, a training engine, and a machine learning model. In alternative embodiments, model training module 316 can include some or all of the functionality described herein but grouped differently into one or more modules. In some embodiments, model trainer module 316 generates a machine learning model based on one or more known machine learning algorithms. In an embodiment, model trainer module 316 includes a training engine that trains a machine learning model using training a dataset. In an embodiment, the training dataset includes a history of conversation data between an SME and an LLM.

In the illustrated embodiment, the model trainer module 316 is configured to train a large language model. In an embodiment, the training process includes fine-tuning, transfer learning, and/or reinforcement learning, to enhance the model's performance and accuracy. Through iterative training iterations, the module refines the model's generation abilities, fine-tunes its parameters, and adjusts its behavior based on the feedback received during the training process. In an embodiment, model trainer module 316 continuously evaluates the model's performance against predefined evaluation metrics and thresholds to monitor training progress and ensure that trained model meets the desired standards of accuracy and quality. By analyzing the model's outputs and comparing them against the defined metrics, the model trainer module 316 iteratively refines the model's training process to optimize generation performance.

In the illustrated embodiment, the API interface module 318 serves as the interface through which users and/or applications interact with the RAG manager and/or agents orchestrated by the RAG manager module 300 and facilitates the exchange of information between the users and/or applications and these modules. In an embodiment, the application interface module 318 is configured to interact with any or all other modules within RAG manager module 300 to retrieve, transmit, store, and/or modify information and/or execute functions and operations as described herein. In some embodiments, API interface module 318 connects with API gateway via any suitable network or combination of networks such as the Internet, etc. and uses any suitable communication protocols such as Wi-Fi, Bluetooth, etc. to connect to external systems required to access to perform certain tasks. Further, the API gateway may transmit service requests received from a client interacting with RAG manager module 300.

In the illustrated embodiment, administrative module 320 allows users with administrative privileges to perform various administrative tasks associated with RAG manager module 300 as described herein. For example, in some embodiments, administrative user module 320 allows a user with administrative privileges to initiate a data collection process. As another example, in some embodiments, administrative module 320 allows a user with administrative privileges to initiate and monitor the training process performed by model training module 316, including setting desired parameters and/or hyperparameters for the training process.

In an embodiment, administrative module 320 includes a user interface configured to allow a user having sufficient privileges to oversee the operation and management of a large language model-based system. In an embodiment, administrator module 320 controls access permissions, monitors system performance, and handles any administrative tasks related to the platform. In an embodiment, the administrator module 320 interacts with any or all other modules to promote compliance with the administrative settings. Further, a backend administration system allows users with administrative privileges to perform various administrative tasks associated with the module as described herein, such as initiating a data collection and/or correlation process, a neural network training process, defining optimization goals, defining execution parameters/criteria, and any other defined settings discussed herein.

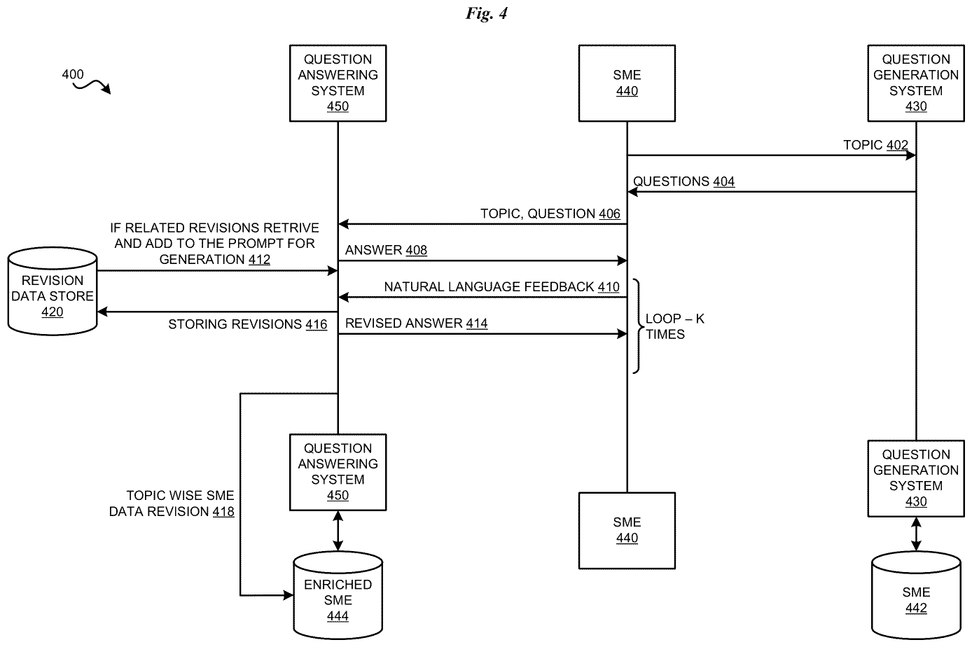

FIG. 4 depicts a block diagram of an example process 400 for retrieval augmented generation error correction. In some embodiments, aspects of the process 400 may be accomplished in whole or in part by the RAG manager module 200 of FIG. 1 and FIG. 2, and/or the RAG manager module 300 of FIG. 3. In an embodiment, the process 400 includes three phases, including a question generation phase, a conversation phase between the SME and the Question Answering System, and an SME data store revision and refinement phase.

In the illustrated embodiment, a subject matter expert (SME) 440 is shown transmitting a topic to a Question-Generating System 430. In an embodiment, during the question generation phase, the process initializes with the SME through a user-proxy agent interacting with the Question Generation System 430. In an embodiment, the Question-Generating System 430 comprises an LLM agent trained to generate a set of questions related to an input prompt topic. In the illustrated embodiment, inputting the Question-Generating System 430 with a prompt containing a topic causes the Question-Generating System 430 to output a set of questions related to the topic. In the illustrated embodiment, the Question-Generating System 430 accesses SME datastore 422 to retrieve data related to the topic input by the SME 440. In an embodiment, the Question-Generating System 430 generates a set of questions based on the SME data stored on the SME datastore 422. In an embodiment, the SME datastore 422 includes topic data related to various topics related to a target system.

In an embodiment, at step 402, the SME 440 initializes the process 400 by inputting a topic to the Question Generation System 430. Question Generation System 430 employs an LLM model that accesses the SME data store 420 and filters the documents based on the topic and provides the topic related documents to the Question Generation System 430. The LLM configured for the Question Generation System 430 is tasked with the question generation. In an embodiment, the LLM may be prompt tuned to generate questions based on the topic related documents. The LLM analyses the document content and generates a set of questions and returns the list of questions for all the topic related documents as a response to the SME 440.

In an embodiment, at step 404, upon receiving the input topic, the Question Generation System 430 generates a set of questions based on the input topic. In the illustrated embodiment, the Question Generation System 430 accesses SME datastore 422 to retrieve the input topic and data associated with the input topic to generate a set of questions based on the input topic. In an embodiment, the SME selects a portion of the questions generated by the Question Generation System 430 for further processing by a Question Answering System 450.

In an embodiment, at step 406, the SME 440 transmits the topic and a question generated by the Question-Generating System 430 to the Question-Answering System 450. In an embodiment, the Question-Answering System 450 comprises an LLM agent trained to generate a set of answers to a set of questions related to a particular topic. In an embodiment, the Question Answering System 450 employs a RAG process to retrieve data related to the query and provides the query and the retrieved data as context for the LLM to answer the question. The LLM analyses the query, context and provides its response to the SME 440. In an embodiment, the RAG process may fetch relevant data to answer a question from an existing data store and/or outputs a portion of the retrieved data in combination with an answer to the question. In the illustrated embodiment, inputting the Question-Answering System 450 with the prompt containing a topic and a set of questions causes the Question-Answering System 450 to generate and output a set of answers to the set of questions.

An embodiment includes automatically generating questions around a particular subject area and curating questions and answers using natural language with the SME in the loop based architecture. Accordingly, for a topic with a multitude of questions, and with curation of the answers to the questions causes the process to identify knowledge gaps within different topic silos of a database and fills those gaps, thereby creating contextual relationships between features of content corresponding to a particular topic or subject area.

In an embodiment, at step 408, the Question-Answering System 450 transmits the set of answers generated by the Question Answering System 450 to the SME 440. In an embodiment, at step 410, the SME 440 provides natural language-based feedback to the Question-Answering System 450 related to the set of answers generated. In an embodiment, at step 414, the Question-Answering System 450 generates a revised set of answers based on the natural language feedback provided by the SME 440. In an embodiment, the steps of generating answers, providing feedback, generating revised answers, and providing further feedback may be performed iteratively any number of times, a predetermined number of times, or until satisfaction of some defined condition.

Once SME receives an answer generated by the Question-Answering System 450, the SME analyzes the answer against the SME's domain expertise. Accordingly, based on their domain expertise, the SME can determine if the answer is accurate, partially accurate, missing information, incorrect, irrelevant, factually incorrect, or otherwise undesired. For example, in an instance where the answer is partially correct, the SME 440 may provide natural language feedback indicating what part of an answer is incorrect, what type of information should be further included, instructions including what kind of changes should be implemented, and so forth

In an embodiment, upon receiving feedback from the SME 440, the Question-Answering System fetches data from a revision data store 420 to compare the feedback data to data stored on the revision data store 420. In an embodiment, the revision data store 420 includes a database that stores a history of feedback data for previously generated answers. If the LLM identifies a similar previous answer, the LLM processes the associated feedback data corresponding to the similar previous answer, as well as data associated with a previously revised generated answer, to incorporate into its decision-making processes on how to generate a revised answer to a present question based on the present feedback.

In an embodiment, the LLM incorporates a similar revision to the answer based on historical revision data. For example, depending on a part of an answer the SME flags as incorrect, the LLM will go and see if there is some similar kind of revisions mentioned somewhere. In an embodiment, that LLM leverages the previous revision data so LLM to provide guidance on how to revise an answer. In an embodiment, the feedback provided by the SME 440 is stored in the revision data store 420 along with associated answer data. In an embodiment, if no similar revision data is located, the feedback provided by the SME may be stored on the revision data store 420. In an embodiment, the steps of generating answers to questions, providing feedback, and generating revised answers to questions based on feedback and/or revision history data may be performed iteratively until an SME 440 accepts the revised answer and ceases these steps of the process.

During the conversation phase, the SME 440 through the a user proxy agent analyses the response (the list of questions for the topic) provided by the Question Generating agent and chooses a question to start the conversation with the Question Answering agent. The SME examines the answer provided by the Question Answering agent and provides a natural language feedback to the Question Answering agent. The Question Answering agent studies the feedback and through its association with the Revision data store, retrieves the revisions which are similar to the input feedback. Through the retrieved revisions and feedback, the Question Answering agent LLM modifies/revises its previous response to incorporate the feedback and returns the modified answer to the SME. The unique revisions are stored on the revision data store as references to similar revisions for future usage.

The inclusion of the natural language-based feedback by the SME 440 influences the Question-Answering System 450 to generate an output that is influenced by feedback provided by the SME 440. By inputting the LLM with the feedback, the system triggers the model to analyze and interpret the provided information, leading to the generation of a revised answer that aligns with the context and cues presented in the prompt. In some embodiments, the feedback may include specific corrections or provide instructions based on previous answers generated by the model. The model integrates the insights and context provided by natural language-based feedback into its decision-making process.

In an embodiment, at step 412, the Question-Answering System 450 receives relevant information from revision data store 420 that may be incorporated into a revised generated answer to a question. In an embodiment, the revision data store 420 may include any internal or external data source comprising information relevant to providing an accurate output answer to a question. Accordingly, if there is data stored on revision data store 420 that is related to the feedback provided by the SME 440, the Question-Answering System 450 may leverage the data stored on revision data store 420 as part of an input prompt to generate a revised answer. In an embodiment, at step 416, revised answer data may be stored on the revision data store 420.

In an embodiment, at step 418, the process includes performing topic-wise data refinement on answer data generated by the Question-Answering System 450 responsive to receiving input questions generated by Question-Generating System 430 and feedback provided by SME 440. In an embodiment, results of performing topic-wise data refinement on answer data is stored on an enriched SME datastore 444. In an embodiment, the Question-Answering System 450 leverages data stored on the enriched SME datastore 442 to generate output responses based on enriched topic data.

In an embodiment, at step 418, the processing includes performing a topic-wise data revision based on the input topic initially provided to the system. Accordingly, upon receiving the input topic and the answer to one or more questions, the LLM searches the system database for similar text in a document stored on the system database. The process receives relevant text data from any identified documents containing similar text data, and compares the retrieved text data to revision data including the revised answer data to locate additional information to incorporate or aspects of the data to modify based on the pre-existing data stored on the system database. Accordingly, once the Question Answering System 450 determines what the revision is that should be done, the LLM agent goes back and edits this SME data store based on relevant information from the system database to create an enriched SME datastore 444 that comprises example answer with enriched data compared to SME datastore 442.

The pre-existing data stored in a topic data may be refined in the following manner. Data for a particular topic store is enhanced with the extra information which was previously missing in a particular data store. In this manner, the enriched topic data store has any information that was previously missing, based on questions, answers, and feedback provided to answers to the questions. Suppose one topic includes the role of a neuron in an artificial neural network to process information, and another topic includes how do activation functions contribute to the behavior of neural networks. Although the information for explaining what an activation layer is stored in a SME database related to activation functions, the same information is missing from the SME database related to neurons in a neural network. Accordingly, there was a missing interlink between the two topics, and the system previously did not understand that both topics are related to each other. Since the system may not understand the contextual links by default, embodiment of the present disclosure increases contextual understanding on an LLM model by incorporating those words give that context to a particular topic so that the model can now relate between both of the topics. Embodiments of the disclosed process include refining information by filling missing gaps in information by generating questions and the information needed to answer those questions, which develops contextual links within the original data store.

This process of feedback, revision retrieval, revised answer, and revision storing may continue until the response is found to be satisfactory by the SME. On obtaining a satisfactory response from the LLM, the SME will decide on continuing the session with feedback to the LLM and the next question or ending the session with the feedback to the LLM. Based on the SME providing feedback to the Question Generating agent that the answer was satisfactory, the process proceed to data store refinement phase.

In an embodiment, the SME data store refinement process includes a conversation between the User Proxy agent (SME) and the Question Answering agent. The SME data store which has the documents sorted topic wise, will retrieve the document content which corresponded to the query. The retrieved content and the revised/satisfactory answer is compared to identify the misinterpreted/misleading text. This misleading text is then modified based on the satisfactory answer to modify the text. In case there is lack of information, the satisfactory answer can be used to fill in the information and provide completeness and implicitly relate the data in the database.

Suppose the following example scenario illustrating functionality of process 400. Suppose the SME datastore contains various IT related subject matter. For example, the SME datastore 442 may include the following description of an Artificial Neural Network: “An Artificial Neural Network is a computational model that consists of interconnected nodes, called neurons, organized in layers-input layer, hidden layers, and output layer. Each neuron receives input signals, processes them using weighted connections, applies a mathematical function, and passes the output to the next layer. Through a process called training, the network adjusts the weights of connections to learn patterns and relationships in data. The network's ability to learn from data and generalize to unseen examples makes it a useful tool in machine learning and artificial intelligence applications. Activation functions introduce non-linearities into the network's computations.”

Suppose an SME 440 inputs a prompt the system including the topic: “Artificial Neural Network”.

In response, the Question Generation System 430 is tasked with generating questions to related to an Artificial Neural Network. The topic understanding module processes the input topic and extracts key components such as neurons, layers, activation functions, and training algorithms. Based on the extracted information, the question template generation module creates a set of questions to delve into the underlying components of artificial neural networks.

Suppose the Question Generation System 430 generates the following questions to related to the input topic: What is the role of a neuron in an artificial neural network and how does it process information? Explain the concept of different layers in a neural network architecture and their functions. How do activation functions contribute to the behavior of neural networks? Discuss the backpropagation algorithm and its significance in training neural networks. Describe the impact of hyperparameters like learning rate and batch size on the performance of neural networks.

Upon receiving the set of questions generated by the Question Generation System 430, the SME 440 may select one or more questions to transmit to the Question Answering System 450 for processing. For example, suppose the SME selects the question: “What is the role of a neuron in an artificial neural network and how does it process information?

In response to receiving the input prompt, the Question Answering System 450 would analyze the query and may provide the following answer: “A neuron serves as a basic processing unit that receives input signals, applies weights to these inputs, sums them up, and then passes the result through a mathematical function to produce an output.”

The SME 440 may receive the generated response and provide feedback based on the generated answer. For example, the SME 440 may provide the following instruction to the Question Answering System 450: “The answer should explain that the mathematical function used is activation function.”

Upon receiving the feedback instruction, the Question Answering System 450 may generate a revised answer to the question. In an embodiment, the Question Answering system 450 fetches data from the revision data store 420 to locate information relevant to generating a revised answer. Suppose the Question Answering System 450 generates the following revised answer: “A neuron serves as a basic processing unit that receives input signals, applies weights to these inputs, sums them up, and then passes the result through an activation function to produce an output. An activation functions shapes the behavior of a neural networks by introducing non-linearities into the network's computations.”

Once again, the SME 440 may receive the generated response and provide feedback based on the generated answer. Suppose that the SME is satisfied with the revised answer, in which case the SME may provide natural language feedback to the Question Answering system 450 indicating that the revised answer is satisfactory. In an embodiment, providing natural language feedback indicating that the revised answer is satisfactory constitutes reaching an exit criterion, in which case additional revisions are not further generated, and information from the revised answer(s) is stored.

Suppose the enriched SME datastore 444 now includes the following description: “An Artificial Neural Network is a computational model that consists of interconnected nodes, called neurons, organized in layers-input layer, hidden layers, and output layer. Each neuron receives input signals, processes them using weighted connections, applies an activation function, and passes the output to the next layer. Through a process called training, the network adjusts the weights of connections to learn patterns and relationships in data. The network's ability to learn from data and generalize to unseen examples makes it a useful tool in machine learning and artificial intelligence applications. Activation functions shape the behavior of a neural network by introducing non-linearities into the network's computations.” (In the above example, revisions are shown italicized for the purpose of clarity.)

Suppose in a previous instance, the SME 440 input the following question to the Question Answering System 450: “How do activation functions contribute to the behavior of neural networks?” Further, suppose that in response to receiving the question, the Question Answering System 450 previously generated the following answer: “An activation functions shapes the behavior of a neural networks by introducing non-linearities into the network's computations.” Further, suppose upon an analysis of this generated answer, the SME 440 input the following feedback: “Explain what an activation function is.” Further, suppose that in response to receiving the feedback, the Question Answering System 450 generated the following revised answer: “An activation function is a mathematical function applied to the output of a neuron in a neural network. An activation determines whether the neuron should be activated or not based on the weighted sum of its inputs. Common activation functions include sigmoid, tanh, ReLU (Rectified Linear Unit), and SoftMax. These functions help in introducing non-linear transformations to the input data, enabling the network to model and approximate a wide range of functions. The choice of activation function impacts the network's learning capabilities, convergence speed, and ability to generalize to unseen data.”

In the above example, the previous generated question data, answer data, feedback data, and revised answer data may be stored on the revision data store 420. Further, in the above depicted example scenario, the Question Answering system 450 may fetch data from the revision data store 420 to locate information relevant to generating a revised answer based on the instant instruction “Explain what an activation layer is.” For example, the Question Answering System 450 will search the revision data store 420 for similar feedback and will locate the previous feedback instruction “Explain what an activation layer is” and may incorporate relevant information from the previously revised generated answer to update and provide a revised answer to the present question.

An embodiment of the process 400 includes storing the revision type, number of revisions, revision data, feedback data, and so forth. An embodiment of the process 400 includes establishing a confidence threshold. In an embodiment, the process includes updating the confidence threshold each iteration of steps of process. When another Subject Matter Expert (SME) provides instructions to revise the answer in a similar manner, the system retrieves similar feedback based on this factor. By identifying similarities in the feedback provided previously, the system gains context and uses this information to revise the answer. The revised answer is then modified based on the feedback provided by the SME, leading to an increase in confidence that the correct data has been modified. Through iterations where similar revisions and feedback are identified, the system incrementally increases its confidence score. When the system recognizes that the revision and feedback are of a similar kind, it raises its confidence score.

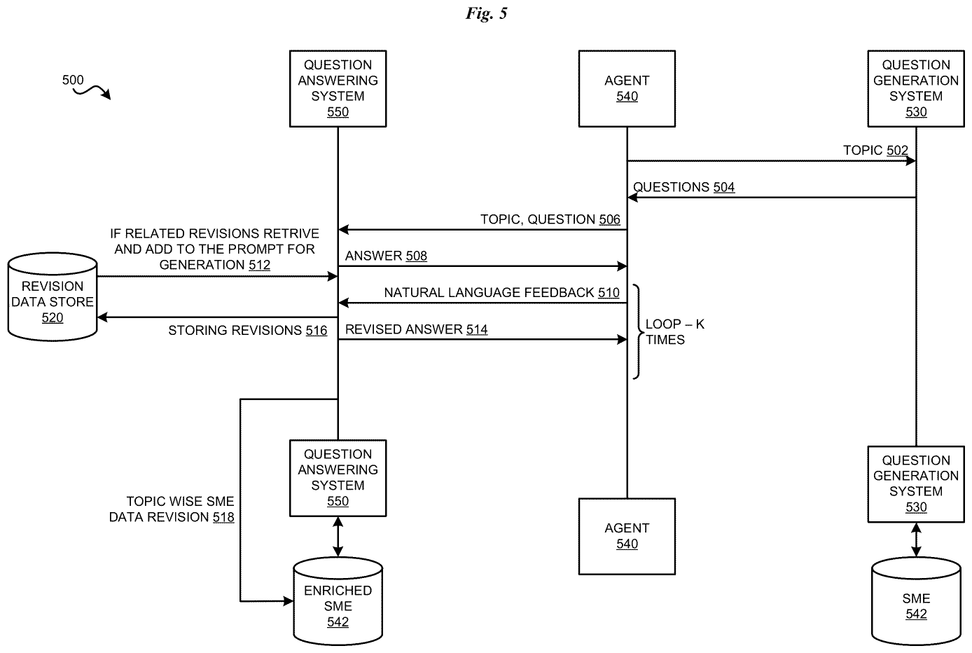

FIG. 5 depicts a block diagram of an example retrieval augmented generation process in accordance with an illustrative embodiment. In some embodiments, aspects of the depicted process 500 may be executed in whole or in part by the RAG manager module 200 of FIGS. 1 and 2 and/or RAG manager module 300 of FIG. 3. In an embodiment, process 500 includes aspects of process 400 depicted by FIG. 4. Accordingly, FIG. 5 depicts an example embodiment of the disclosed process where the roles of the SME are performed by an SME agent 540.

In an embodiment, the SME agent 540 comprises an the LLM based agent programmed with domain-specific knowledge and expertise relevant to an SME's area of specialization. This involves training the LLM on a diverse range of documents, research papers, and data sources related to the specific field in which the SME operates. By doing so, the LLM can acquire a deep understanding of the subject matter and be able to provide insights, answers, and solutions similar to those of a human SME.

In an embodiment, training an SME agent 550 includes training based on examples of how a human SME (or another virtual SME agent) has provided feedback to answers generated by an LLM in previous instances. Initially, the LLM generates responses to queries or tasks within the SME's domain of expertise. These responses are then presented to the human SME or virtual SME agent for evaluation and feedback.

The training data, including the LLM's generated responses and the corresponding feedback from the SME, is used to train the SME agent through one or more machine learning algorithms. The SME agent 540 learns to analyze and evaluate responses similar to how the human SME or virtual SME agent does, based on the feedback provided. The training process aims to teach the SME agent to distinguish between satisfactory versus unsatisfactory responses, understand the nuances of the domain, and improve the quality of answers generated by the LLM.

By iteratively training the SME agent on a diverse set of examples and feedback from human SMEs or virtual SME agents, the agent can develop the ability to assess the LLM's responses effectively and provide accurate feedback. The trained SME agent 540 can then be deployed to evaluate the LLM's responses autonomously, providing insights and guidance to enhance the LLM's performance and ensure the accuracy and reliability of the generated answers within the domain of expertise.

In the illustrated embodiment, an SME agent 540 is shown transmitting a topic to a Question-Generating System 530. In an embodiment, during the question generation phase, the process initializes with the SME agent 540 interacting with the Question Generation System 530. In an embodiment, the Question-Generating System 530 comprises an LLM agent trained to generate a set of questions related to an input prompt topic. In the illustrated embodiment, inputting the Question-Generating System 530 with a prompt containing a topic causes the Question-Generating System 530 to output a set of questions related to the topic. In the illustrated embodiment, the Question-Generating System 530 accesses SME datastore 522 to retrieve data related to the topic input by the SME agent 540. In an embodiment, the Question-Generating System 530 generates a set of questions based on the SME data stored on the SME datastore 522. In an embodiment, the SME datastore 522 includes topic data related to various topics related to a target system.

In an embodiment, at step 502, the SME agent 540 initializes the process 500 by inputting a topic to the Question Generation System 530. Question Generation System 530 employs an LLM model that accesses the SME data store 520 and filters the documents based on the topic and provides the topic related documents to the Question Generation System 530. The LLM configured for the Question Generation System 530 is tasked with the question generation. In an embodiment, the LLM may be prompt tuned to generate questions based on the topic related documents. The LLM analyses the document content and generates a set of questions and returns the list of questions for all the topic related documents as a response to the SME agent 540.

In an embodiment, at step 504, upon receiving the input topic, the Question Generation System 530 generates a set of questions based on the input topic. In the illustrated embodiment, the Question Generation System 530 accesses SME datastore 522 to retrieve the input topic and data associated with the input topic to generate a set of questions based on the input topic. In an embodiment, the SME agent 540 selects a portion of the questions generated by the Question Generation System 530 for further processing by a Question Answering System 550.

In an embodiment, at step 506, the SME 540 transmits the topic and a question generated by the Question-Generating System 530 to the Question-Answering System 550. In an embodiment, the Question-Answering System 550 comprises an LLM agent trained to generate a set of answers to a set of questions related to a particular topic. In an embodiment, the Question Answering System 550 employs a RAG process to retrieve data related to the query and provides the query and the retrieved data as context for the LLM to answer the question. The LLM analyses the query, context and provides its response to the SME agent 540. In an embodiment, the RAG process may fetch relevant data to answer a question from an existing data store and/or outputs a portion of the retrieved data in combination with an answer to the question. In the illustrated embodiment, inputting the Question-Answering System 550 with the prompt containing a topic and a set of questions causes the Question-Answering System 550 to generate and output a set of answers to the set of questions.

An embodiment includes automatically generating questions around a particular subject area and curating questions and answers using natural language with the SME in the loop based architecture. Accordingly, for a topic with a multitude of questions, and with curation of the answers to the questions causes the process to identify knowledge gaps within different topic silos of a database and fills those gaps, thereby creating contextual relationships between features of content corresponding to a particular topic or subject area.

In an embodiment, at step 508, the Question-Answering System 450 transmits the set of answers generated by the Question Answering System 450 to the SME 540. In an embodiment, at step 510, the SME 540 provides natural language-based feedback to the Question-Answering System 450 related to the set of answers generated. In an embodiment, at step 514, the Question-Answering System 550 generates a revised set of answers based on the natural language feedback provided by the SME agent 540. In an embodiment, the steps of generating answers, providing feedback, generating revised answers, and providing further feedback may be performed iteratively any number of times, a predetermined number of times, or until satisfaction of some defined condition.

Once SME agent 550 receives an answer generated by the Question-Answering System 450, the SME agent 550 analyzes the answer against the SME's domain expertise. Accordingly, based on their domain expertise, the SME agent 550 can determine if the answer is accurate, partially accurate, missing information, incorrect, irrelevant, factually incorrect, or otherwise undesired. For example, in an instance where the answer is partially correct, the SME agent 540 may provide natural language feedback indicating what part of an answer is incorrect, what type of information should be further included, instructions including what kind of changes should be implemented, and so forth

In an embodiment, upon receiving feedback from the SME agent 540, the Question-Answering System 550 fetches data from a revision data store 520 to compare the feedback data to data stored on the revision data store 520. In an embodiment, the revision data store 520 includes a database that stores a history of feedback data for previously generated answers. If the LLM identifies a similar previous answer, the LLM processes the associated feedback data corresponding to the similar previous answer, as well as data associated with a previously revised generated answer, to incorporate into its decision-making processes on how to generate a revised answer to a present question based on the present feedback.

In an embodiment, the LLM incorporates a similar revision to the answer based on historical revision data. For example, depending on a part of an answer the SME flags as incorrect, the LLM will go and see if there is some similar kind of revisions mentioned somewhere. In an embodiment, that LLM leverages the previous revision data so LLM to provide guidance on how to revise an answer. In an embodiment, the feedback provided by the SME 540 is stored in the revision data store 520 along with associated answer data. In an embodiment, if no similar revision data is located, the feedback provided by the SME may be stored on the revision data store 520. In an embodiment, the steps of generating answers to questions, providing feedback, and generating revised answers to questions based on feedback and/or revision history data may be performed iteratively until an SME 440 accepts the revised answer and ceases these steps of the process.

During the conversation phase, the SME agent 540 analyses the response (the list of questions for the topic) provided by the Question Generation System 530 and chooses a question to start the conversation with the Question Answering agent 550. The SME agent 540 examines the answer provided by the Question Answering agent 550 and provides natural language feedback to the Question Answering System 550. The Question Answering System 550 compares the feedback and through its association with the revision data store 520 and retrieves the revisions which are similar to the input feedback. Through the retrieved revisions and feedback, the Question Answering System 550 LLM modifies/revises its previous response to incorporate the feedback and returns the modified answer to the SME agent 540. The unique revisions are stored on the revision data store 520 as references to similar revisions for future usage.

The inclusion of the natural language-based feedback by the SME agent 540 influences the Question-Answering System 550 to generate an output that is influenced by feedback provided by the SME 540. By inputting the LLM with the feedback, the system triggers the model to analyze and interpret the provided information, leading to the generation of a revised answer that aligns with the context and cues presented in the prompt. In some embodiments, the feedback may include specific corrections or provide instructions based on previous answers generated by the model. The model integrates the insights and context provided by natural language-based feedback into its decision-making process.

In an embodiment, at step 512, the Question-Answering System 550 receives relevant information from revision data store 520 that may be incorporated into a revised generated answer to a question. In an embodiment, the revision data store 520 may include any internal or external data source comprising information relevant to providing an accurate output answer to a question. Accordingly, if there is data stored on revision data store 520 that is related to the feedback provided by the SME 540, the Question-Answering System 550 may leverage the data stored on revision data store 520 as part of an input prompt to generate a revised answer. In an embodiment, at step 516, revised answer data may be stored on the revision data store 520.

In an embodiment, at step 518, the process includes performing topic-wise data refinement on answer data generated by the Question-Answering System 550 responsive to receiving input questions generated by Question-Generating System 530 and feedback provided by SME 440. In an embodiment, results of performing topic-wise data refinement on answer data is stored on an enriched SME datastore 444. In an embodiment, the Question-Answering System 450 leverages data stored on the enriched SME datastore 442 to generate output responses based on enriched topic data.

In an embodiment, at step 518, the processing includes performing a topic-wise data revision based on the input topic initially provided to the system. Accordingly, upon receiving the input topic and the answer to one or more questions, the LLM searches the system database for similar text in a document stored on the system database. The process receives relevant text data from any identified documents containing similar text data, and compares the retrieved text data to revision data including the revised answer data to locate additional information to incorporate or aspects of the data to modify based on the pre-existing data stored on the system database. Accordingly, once the Question Answering System 550 determines what the revision is that should be done, the LLM agent goes back and edits this SME data store based on relevant information from the system database to create an enriched SME datastore 544 that comprises example answer with enriched data compared to SME datastore 542.

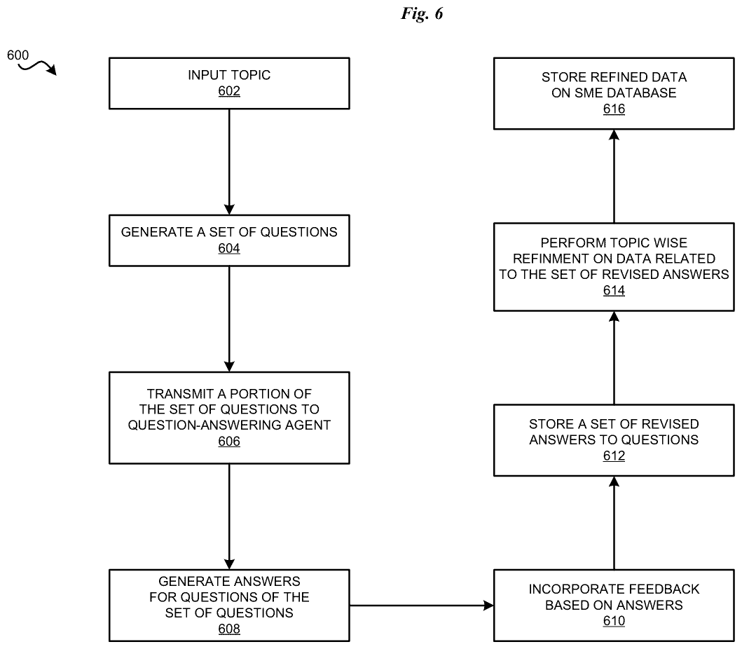

FIG. 6 depicts a flowchart of an example process for prompt debugging in accordance with an illustrative embodiment. In an embodiment, RAG manager module 200 of FIGS. 1 and 2, RAG manager module 300 of FIG. 3 carries out some or all of the steps of process 600.

In an embodiment, at step 602, the process includes receiving an input topic. The system accepts a topic input provided by the user or another source, which serves as the starting point for generating questions and answers. The input topic is used to guide the subsequent steps of the process and determine the scope of information to be covered.

In an embodiment, at step 604, the process includes generating a set of questions responsive to receiving the input topic. Utilizing the input topic, the system generates a series of questions that are relevant and informative based on the topic's context. These questions are designed to explore different aspects of the topic and facilitate a comprehensive understanding of a topic.

In an embodiment, at step 606, the process includes transmitting a portion of the questions to a question-answering agent. A selection of questions from the generated set is forwarded to the question-answering agent for processing. These questions are chosen based on criteria such as relevance, complexity, and user feedback to ensure that the question-answering agent focuses on addressing key inquiries.

In an embodiment, at step 608, the process includes generating a set of answers to the portion of the questions. In an embodiment, the question-answering agent generates a set of answers upon receiving the portion of questions. The question-answering agent formulates responses to the questions received, leveraging its knowledge base and algorithms to provide accurate and informative answers. The answers are tailored to address the specific queries posed in the selected questions.

In an embodiment, at step 610, the process includes incorporating feedback from a SME to the set of answers. In an embodiment, the SME analyzes the content of the set of answers and modifies the content of the answers depending on the content. In an embodiment, modifying the content of the set of answers produces a set of revised answers to the questions. The SME reviews the content of the answers provided by the question-answering agent and offers insights, corrections, or additional information to enhance the accuracy and quality of the responses. The feedback from the SME is used to refine and improve the answers. In an embodiment, the SME analyzes the content of the set of answers and modifies the content of the answers depending on the feedback. The SME evaluates the answers in terms of correctness, relevance, and depth of information, making adjustments or additions as necessary to ensure the responses align with expert knowledge and standards.

In an embodiment, at step 612, the process includes storing a set of revised answers to the questions. The system saves the updated answers in a storage repository for future reference and retrieval. The revised answers serve as a resource for improving the knowledge base of the system and enhancing the quality of responses provided to users over time.

In an embodiment, at step 614, the process includes performing a topic wise refinement on data related to the set of revised answers. During this step, the system conducts a detailed analysis and enhancement of the information contained in the set of revised answers. The refinement process focuses on organizing, clarifying, and augmenting the data to ensure that it is accurate, comprehensive, and aligned with the specific topic addressed in the answers. This topic-wise refinement involves verifying facts, correcting errors, adding relevant details, and structuring the data in a coherent manner to enhance its quality and relevance.

In an embodiment, at step 616, the process includes storing refined data on the SME database. In an embodiment, the refined data is stored on an enriched SME datastore. The refined data includes the updated answers, additional insights provided by subject matter experts, and any other relevant details that have been incorporated during the refinement process. By storing the refined data in the SME database, the system ensures that the latest and most accurate information is available for future reference, question generation, and answer provision. The refined data contributes to enriching the knowledge base of the system and improving the overall quality of responses provided to users.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
receiving a first input topic by a question generating agent;
generating using the question generating agent a first set of question based on the first input topic;
generating using a question-answering agent a first answer to a first question of the first set of questions;
causing, responsive to the generating the first answer, an execution of a first program instruction to transmit feedback data to the question-answering agent, the feedback data produced by analyzing content of the first answer;
causing, responsive to receiving the feedback data, an execution of a second program instruction to modify a portion of the first answer based on the feedback data, the execution of the second program instruction producing a revised first answer; and
causing, responsive to producing the revised first answer, an execution of a third program instruction to update an SME database corresponding to the first input topic, wherein updating the SME database comprises modifying existing data on the SME database based on the revised first answer.

2. The computer-implemented method of claim 1, wherein the execution of the second program instruction to modify a portion of the first answer based on the feedback data is performed iteratively until satisfaction of an exit criterion.

3. The computer-implemented method of claim 2, wherein the exit criterion comprises meeting a predefined confidence threshold.

4. The computer-implemented method of claim 2, wherein the exit criterion comprises receiving natural language feedback indicating satisfaction with the revised answer.

5. The computer-implemented method of claim 1, wherein the feedback data comprises an instruction to incorporate additional data.

6. The computer-implemented method of claim 1, wherein the feedback data comprises an instruction to remove data.

7. The computer-implemented method of claim 1, wherein the execution of the second program instruction to modify a portion of the first answer based on the feedback data further comprises comparing the feedback data to historical feedback data, and upon locating an instance of similar feedback data, retrieving stored information corresponding to the instance of the similar feedback data.

8. The computer-implemented method of claim 1, further comprising:
causing, responsive to updating the SME database corresponding to the first input topic responsive, an execution of a fourth program instruction to perform a topic-wise refinement process, the topic-wise refinement process producing an enriched SME database.

9. A computer program product comprising one or more computer readable storage media, and program instructions collectively stored on the one or more computer readable storage media, the program instructions executable by a processor to cause the processor to perform operations comprising:
receiving a first input topic by a question generating agent;
generating using the question generating agent a first question based on the first input topic;
generating using a question-answering agent a first answer to the first question;
causing, responsive to the generating the first answer, an execution of a first program instruction to transmit feedback data to the question-answering agent, the feedback data produced by analyzing content of the first answer;
causing, responsive to receiving the feedback data, an execution of a second program instruction to modify a portion of the first answer based on the feedback data, the execution of the second program instruction producing a revised first answer; and
causing, responsive to producing the revised first answer, an execution of a third program instruction to update a SME database corresponding to the first input topic, wherein updating the SME database comprises incorporating additional data from the revised first answer into the SME database.

10. The computer program product of claim 9, wherein the stored program instructions are stored in a computer readable storage device in a data processing system, and wherein the stored program instructions are transferred over a network from a remote data processing system.

11. The computer program product of claim 9, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

12. The computer program product of claim 9, wherein the execution of the second program instruction to modify a portion of the first answer based on the feedback data is performed iteratively until satisfaction of an exit criterion.

13. The computer program product of claim 12, wherein the exit criterion comprises meeting a predefined confidence threshold.

14. The computer program product of claim 12, wherein the exit criterion comprises receiving natural language feedback indicating satisfaction with the revised answer.

15. The computer program product of claim 9, wherein the feedback data comprises an instruction to incorporate additional data.

16. The computer program product of claim 9, wherein the feedback data comprises an instruction to remove data.

17. The computer program product of claim 9, wherein the execution of the second program instruction to modify a portion of the first answer based on the feedback data further comprises comparing the feedback data to historical feedback data, and upon locating an instance of similar feedback data, retrieving stored information corresponding to the instance of the similar feedback data.

18. The computer program product of claim 9, further comprising:
causing, responsive to updating the SME database corresponding to the first input topic responsive, an execution of a fourth program instruction to perform a topic-wise refinement process, the topic-wise refinement process producing an enriched SME database.

19. A computer system comprising a processor and one or more computer readable storage media, and program instructions collectively stored on the one or more computer readable storage media, the program instructions executable by the processor to cause the processor to perform operations comprising:
receiving a first input topic by a question generating agent;
generating using the question generating agent a first question based on the first input topic;
generating using a question-answering agent a first answer to the first question;
causing, responsive to the generating the first answer, an execution of a first program instruction to transmit feedback data to the question-answering agent, the feedback data produced by analyzing content of the first answer;
causing, responsive to receiving the feedback data, an execution of a second program instruction to modify a portion of the first answer based on the feedback data, the execution of the second program instruction producing a revised first answer; and
causing, responsive to producing the revised first answer, an execution of a third program instruction to update a SME database corresponding to the first input topic, wherein updating the SME database comprises incorporating additional data from the revised first answer into the SME database.

20. The computer system of claim 19, further comprising:
causing, responsive to updating the SME database corresponding to the first input topic, an execution of a fourth program instruction to perform a topic-wise refinement process, the topic-wise refinement process producing an enriched SME database.
